(19) United States
(12) Patent Application Publication
(10) Pub. No.: US 2023/0320284 A1
(43) Pub. Date: Oct. 12, 2023

(54) LOCAL COLD/WARM PAD FOR STRAWBERRY CULTIVATION

(71) Applicant: Yong Seok KIM, Iksan-si (KR)

(72) Inventor: Yong Seok KIM, Iksan-si (KR)

(21) Appl. No.: 18/022,322

(22) PCT Filed: Aug. 11, 2021
(86) PCT No.: PCT/KR2021/010629

§ 371 Date: Feb. 21, 2023

(30) Foreign Application Priority Data
Sep. 8, 2020 (KR) 20-2020-0003252

(51) Int. Cl. A01G 13/06; A01G 22/05; A01G 25/02

(52) U.S. Cl. CPC A01G 13/06; A01G 22/05; A01G 25/026

(57) ABSTRACT

The present invention provides a local cold/warm pad for strawberry cultivation, the local cold/warm pad including: a geothermal hose unit (102) configured such that supply hose part bodies (10 and 11) through which cold water or hot water is supplied are formed, a discharge hose part (12) is formed between the supply hose part bodies (10 and 11), the discharge hose part (12) and the supply hose part bodies (10 and 11) are fused to form fusion portions (14), and a plurality of pin holes are formed in the fusion portions (14); dripping hose units (104) seated on and fixed to the fusion portions (14), and provided with a plurality of nozzle holes (32) for supplying irrigation water to crops; and fixing members (106) configured to fix the dripping hose units (104) seated on the fusion portions so that the dripping hose units (104) are not shaken or separated.

### TECHNICAL FIELD

The present invention relates generally to a local cold/warm pad for strawberry cultivation, and more particularly to a local cold/warm pad for strawberry cultivation that enables high-quality strawberries to be harvested by providing uniform geothermal heat in such a way as to adjust the temperature of water supplied in seedling and growth stages, requiring water supply during strawberry cultivation, in accordance with the season, and also enables profitability to be improved by increasing a harvesting period in such a way as to enable multiple differentiation.

### BACKGROUND ART

In general, when crops are cultivated, water is supplied through hose piping or spraying. The method of supplying water varies according to the growing stage of crops.

In addition, when crops such as strawberries are cultivated, water is sprayed onto adjacent crops by using a sprinkler or a spray hose after seedlings are transplanted and until the roots of seeded crops are established, and water is supplied by using a dripping hose after the roots of crops are established and until vinyl mulching is performed.

In addition, when strawberries were cultivated, straw or rice hulls were used to keep warm on the ridges of a strawberry cultivation field. Recently, strawberries are cultivated in a state in which a cultivation field is covered with mulching films made of materials such as polyethylene or polyvinyl chloride.

Mulching films are used for other crops in open fields or during facility cultivation for the purpose of maintaining soil moisture, controlling geothermal temperature, suppressing weeds, preventing soil contamination or preventing infectious diseases.

However, mulching films are not safe from soil contamination. In particular, in the case of strawberries, strawberries come into contact with the surfaces of mulching films and deteriorate, thus resulting in poor marketability, and also mulching films have bad ventilation, which is pointed out as a factor in the occurrence of gray mold.

In addition, strawberries should be irrigated every day to promote differentiation in the hot summer season. However, sprinklers, etc. conventionally used for the irrigation of seedlings have the disadvantage of not only scattering anthrax by water droplets but also causing the spread of anthrax by creating high-temperature and high-humidity conditions. When strawberry seedlings are grown, it is difficult to withstand the high-temperature environment in July and August, so that air conditioning is used for cooling. In this case, cooling costs are excessively high, so that it is not economical at all. Various methods for lowering the indoor temperature at low cost have been attempted, but an effective method has not yet been developed.

As described above, strawberries are sensitive to temperature. Accordingly, when strawberries are set at an appropriate growth temperature of 20 degrees, they grow well and have excellent marketability, so that they should be kept cool in summer and warm in winter. If the temperature of irrigation water is not adjusted and supply water is excessively cold or hot, the temperature cannot be adjusted, so that problems arise in that deformity occurs during strawberry cultivation and a product value is deteriorated.

In addition, profits are generated for farmers when the harvest period of strawberries is extended by enabling multiple differentiation in such a way as to stimulate the growth of strawberries. In the case of strawberry farms, there was no way to enable multiple differentiation, and there is a very difficult problem.

(Patent document 1) Korean Utility Model Registration No. 20-0362835

(Patent document 2) Korean Patent No. 10-1205554

### DISCLOSURE

### Technical Problem

The present invention has been conceived to overcome the above-described problems, and an object of the present invention is to provide a local cold/warm pad for strawberry cultivation that allows the temperature of irrigation water supplied in a seedling stage or growth stage of strawberries or in the season such as summer or winter to be appropriately adjusted to the best temperature and the water whose temperature has been adjusted to be supplied, thereby enabling high-quality strawberries to be grown.

An object of the present invention is to provide a local cold/warm pad for strawberry cultivation that provides medicinal solution and supply water at a necessary place and at a necessary time using a pad for supplying irrigation water, so that the multiple differentiation of strawberries can be performed at least 2-4 times, thereby enabling a harvest period to be extended.

An object of the present invention is to provide a local cold/warm pad for strawberry cultivation that provides warm water in winter, thereby collecting and simultaneously removing insects that adversely affect strawberry cultivation.

### Technical Solution

The present invention provides a local cold/warm pad for strawberry cultivation, the local cold/warm pad including: a geothermal hose unit (102) configured such that supply hose part bodies (10 and 11) through which cold water or hot water is supplied are formed, a discharge hose part (12) is formed between the supply hose part bodies (10 and 11), the discharge hose part (12) and the supply hose part bodies (10 and 11) are fused to form fusion portions (14), and a plurality of pin holes are formed in the fusion portions (14); dripping hose units (104) seated on and fixed to the fusion portions (14), and provided with a plurality of nozzle holes (32) for supplying irrigation water to crops; and fixing members (106) configured to fix the dripping hose units (104) seated on the fusion portions so that the dripping hose units (104) are not shaken or separated.

Preferably, the geothermal hose unit (102) and the dripping hose units (104) are located on top of a ridge (300), strawberry seedlings are planted on the left and right sides of the geothermal hose unit (102), and cold irrigation water is supplied from the dripping hose units (104) so that differentiation can be performed at least twice.

Preferably, the geothermal hose unit (102) is formed of the supply hose part bodies (10 and 11) and the discharge hose part (12), one end of the geothermal hose unit (102) is formed such that the supply hose part bodies (10 and 11) and the discharge hose part (12) are connected to each other so that irrigation water can be circulated therethrough, installation is made such that irrigation water supplied to the supply hose part bodies (10 and 11) is circulated and discharged to the discharge hose part (12), and installation is made such that the sum of the temperature of irrigation water supplied and the temperature of irrigation water discharged is kept uniform throughout hoses extending from the front end of the geothermal hose unit (102) to the rear end thereof.

### Advantageous Effects

As described above, the local cold/warm pad for strawberry cultivation of the present invention has the effect of preventing the deformity of strawberries and improving marketability excellently by providing irrigation water temperature in accordance with the season such as summer or winter, and has the effect of greatly improving productivity by providing irrigation water at the necessary times, so that multiple differentiation can be performed at least twice, thereby increasing the harvest time.

In addition, the present invention has the effect of greatly promoting the profits of farmhouses by improving productivity and profitability in such a way as to easily adjust the temperature of irrigation water for each season and prevent pests such as insects in winter.

### DESCRIPTION OF DRAWINGS

FIG. 1 is a perspective view showing the structure of a local cold/warm pad for strawberry cultivation of the present invention;

FIG. 2 is an exploded perspective view showing the structure of the local cold/warm pad for strawberry cultivation of the present invention;

FIG. 3 is a sectional view showing the structure of the local cold/warm pad for strawberry cultivation of the present invention; and

FIG. 4 is an installation state diagram showing a state in which the local cold/warm pad for strawberry cultivation of the present invention is installed.

### MODE FOR INVENTION

In order to achieve the above objects, the present invention provides a local cold/warm pad including: a geothermal hose unit 102 configured such that supply hose part bodies 10 and 11 through which cold water or hot water is supplied are formed, a discharge hose part 12 is formed between the supply hose part bodies 10 and 11, the discharge hose part 12 and the supply hose part bodies 10 and 11 are fused to form fusion portions 14, and a plurality of pin holes are formed in the fusion portions 14; dripping hose units 104 seated on and fixed to the fusion portions 14, and provided with a plurality of nozzle holes 32 for supplying irrigation water to crops; and fixing members 106 configured to fix the dripping hose units 104 seated on the fusion portions so that the dripping hose units 104 are not shaken or separated. The geothermal hose unit 102 and the dripping hose units 104 are located on top of a ridge 300, strawberry seedlings are planted on the left and right sides of the geothermal hose unit 102, and cold irrigation water is supplied from the dripping hose units 104 so that differentiation can be performed at least twice. The geothermal hose unit 102 is formed of the supply hose part bodies 10 and 11 and the discharge hose part 12, one end of the geothermal hose unit 102 is formed such that the supply hose part bodies 10 and 11 and the discharge hose part 12 are connected to each other so that irrigation water can be circulated therethrough, installation is made such that irrigation water supplied to the supply hose part bodies 10 and 11 is circulated and discharged to the discharge hose part 12, and installation is made such that the sum of the temperature of irrigation water supplied and the temperature of irrigation water discharged is kept uniform throughout hoses extending from the front end of the geothermal hose unit 102 to the rear end thereof.

A specific embodiment according to the local cold/warm pad for strawberry cultivation of the present invention will be described below.

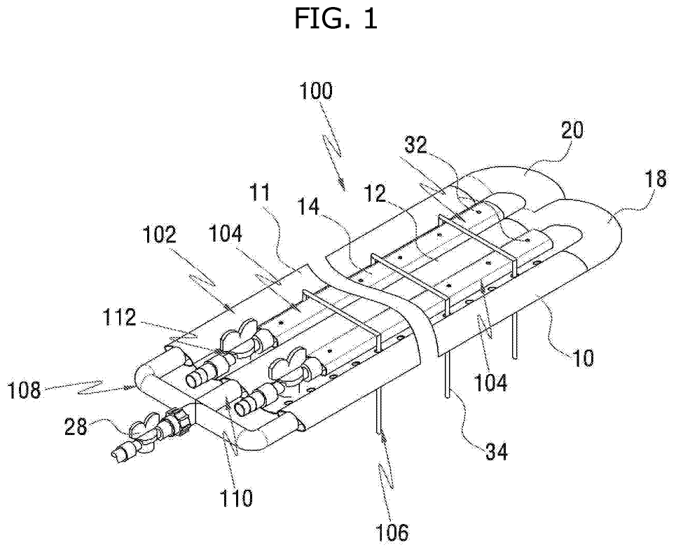

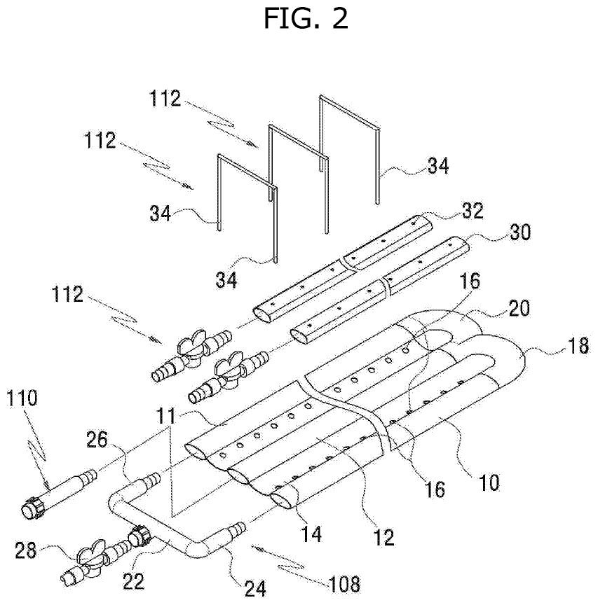

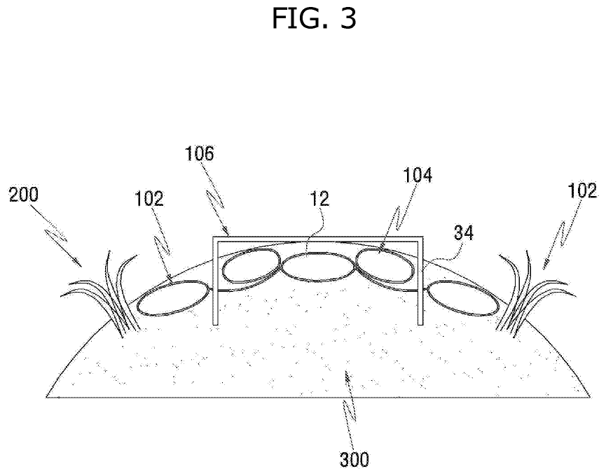

FIG. 1 is a perspective view showing the structure of a local cold/warm pad for strawberry cultivation of the present invention, FIG. 2 is an exploded perspective view showing the structure of the local cold/warm pad for strawberry cultivation of the present invention, and FIG. 3 is a sectional view showing the structure of the local cold/warm pad for strawberry cultivation of the present invention.

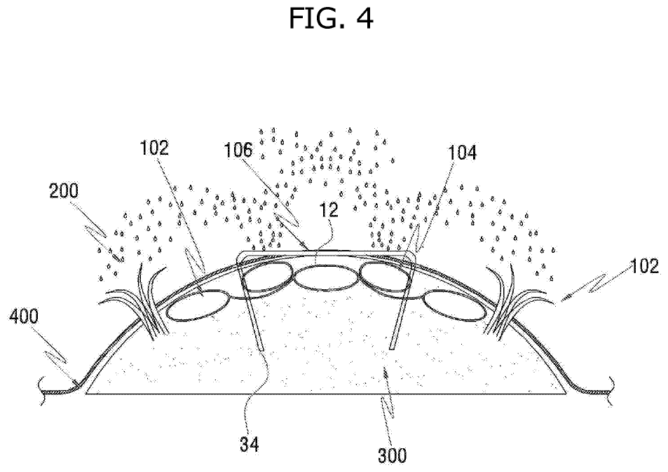

In addition, FIG. 4 is an installation state diagram showing a state in which the local cold/warm pad for strawberry cultivation of the present invention is installed.

The local cold/warm pad for strawberry cultivation of the present invention will be described with reference to FIGS. 1 to 4. First, referring to FIGS. 1 to 3, the local cold/warm pad 100 of the present invention includes a geothermal hose unit 102 configured to cover a ridge and provide geothermal heat in order to cultivate crops such as watermelons, strawberries, or the like, dripping hose units 104 configured to be placed on top of and fixed to the geothermal hose unit 102 and supply irrigation water to crops such as watermelons, strawberries, or the like, and fixing members 106 configured to fix the dripping hose units 104.

In addition, there are provided a connection valve 108 configured to connect one end of the geothermal hose unit 102 and supply cold water or hot water, a discharge valve 110 configured to recover and discharge supplied irrigation water, and supply valves 112 connected to first ends of the dripping hose units 104 and supply irrigation water or a chemical solution such as fertilizer or liquid fertilizer.

The geothermal hose unit 102 provided to supply warm geothermal heat to cultivate crops such as strawberries or the like is provided with two supply hose part bodies 10 and 11, and a discharge hose part 12 is formed between the supply hose part bodies 10 and 11.

The supply hose body parts 10 and 11 and the discharge hose part 12 are connected to each other by fusion portions 14.

The supply hose part bodies 10 and 11 are formed in an elliptical shape in lateral directions, the discharge hose part 12 is formed in the intermediate part, the right portion of the supply hose part body 10 and the left portion of the discharge hose part 12 are welded and connected by the fusion portion 14, and the left portion of the supply hose part body 11 and the right portion of the discharge hose part 12 are fused to each other to form the fusion portion 13.

The fusion portion 13 is formed to be concave downward, and is configured to seat a dripping hose to be described later. That is, as shown in FIG. 1, the dripping hose units 104 are seated and installed on the top between the supply hose part bodies 10 and 11 and the discharge hose part 12.

First ends of the supply hose part bodies 10 and 11 and the discharge hose part 12 are connected to each other, and are connected to each other such that the irrigation water supplied to the supply hose part bodies 10 and 11 is circulated through the discharge hose part 12 and discharged to the outside.

In addition, the fixing members 106 are installed while crossing the dripping hose units 104 in the lateral directions, and are fixed to the ridge downward.

In this case, the fixing members 106 are formed in a sideways U shape or a stapler shape, and are preferably fixed to the ground in order to surround and fix the dripping hose unit 102. The fixing members 106 embedded in the ground or the ridge 300 are fixed such that the width of the fixing legs 34 thereof comes closer and narrower than the width of the upper sides thereof downward toward the centers thereof so that they are not easily removed from the ground and are firmly buried therein.

The supply hose part bodies 10 and 11 are connected by the supply connection valve 108, and irrigation water is supplied through the supply connection valve 108.

In addition, the discharge valve 110 is connected to the discharge hose part 12, and the water supplied through the supply hose part bodies 10 and 11 is circulated and introduced into the discharge hose part 12 and then discharged through the discharge valve 110.

Cold water is supplied to the supply hose part bodies 10 and 11 in summer and hot water is supplied to them in winter.

In winter, when hot water of about 40° C. is supplied through the supply hose part bodies 10 and 11, the temperature of the water becomes about 35° C. at the end of the supply hose part bodies 10 and 11 and the temperature thereof decreases to about 30° C. in the discharge hose part 12 and is then discharged. Accordingly, the temperature of geothermal heat is formed higher than the outside temperature. As a result, geothermal heat is maintained at an appropriate or average temperature required for cultivating crops.

In addition, in summer, geothermal heat is formed lower than the outside temperature by supplying cold water, so that geothermal heat can be maintained at the temperature at which strawberries grow well. When crops such as strawberries are cultivated, strawberries are shocked by supplying cold water several times through the dripping hose units 104 so that multiple differentiation can be performed at least twice. When strawberries are cultivated, the harvesting period thereof may be extended by three months, so that profitability and marketability are improved excellently. In other words, when strawberries are cultivated, they are usually grown from December to June. However, the harvesting period of strawberries may be extended to September by further performing differentiation three or four times.

Referring to FIG. 2, a more detailed description will be given. The geothermal hose unit 102 is formed of the supply hose part bodies 10 and 11, the discharge hose part 12 is formed between the supply hose part bodies 10 and 11, the supply hose part body 10 and the discharge hose part 12 are connected by the fusion portion 14, and the supply hose part body 11 and the discharge hose part 12 are also connected by the fusion portion 14.

A plurality of pin holes 16 are successively formed in the fused portion 14, and fixation is performed by inserting the fixing members 106 having a sideways U shape or a stapler shape into the pin holes 16.

In addition, hot water is supplied through the supply hose body part bodies 10 and 11 so that warmness can be maintained by supplying heat to a ridge so that crops such as watermelon and strawberry grow well.

Connection pipe parts 18 and 20 are formed by connecting the ends of the supply hose part bodies 10 and 11 to the discharge hose part 12 so that supplied water can be circulated, and the connection valve 108 through which irrigation water is supplied is installed at the front end of the supply hose part bodies 10 and 11.

The connection valve 108 is formed of the valve body 22 in a sideways U shape, supply parts 24 and 26 fitted to the supply hose part bodies 10 and 11 are formed in the front of the valve body 22, and a supply control knob 28 configured to control and supply the amount of irrigation water when supplying irrigation water is formed at the rear.

Thereafter, as described above, one end of the discharge hose part 12 is connected to the supply hose part bodies 10 and 11 and circulation is performed, as described above. The discharge valve 110 through which irrigation water is discharged is connected to the front end.

Meanwhile, the dripping hose units 104 are placed and installed on top of the fusion portions 14 of the geothermal hose unit 102.

The plurality of pin holes 16 are formed in the fusion portions 14.

The dripping hose units 104 drip and supply irrigation water so that strawberries grow well during strawberry cultivation. Furthermore, in winter, when the geothermal heat is warmed by the geothermal hose unit 102 and pests such as insects gather, pests may be prevented by injecting an anti-pest liquid and spraying the medicine through the dripping hose units 104.

The dripping hose units 104 are seated and installed on the fusion portions 14 and are formed as cylindrical hose bodies 30, and a plurality of nozzle holes 32 are formed in the hose bodies 30.

The irrigation water required when cultivating crops such as strawberries is supplied to or a chemical solution adapted to prevent pests is injected into the dripping hose units 104, and is dripped and supplied through the nozzle holes 32.

Furthermore, the dripping hose units 104 are seated on top of the fusion portions 14 formed in the geothermal hose unit 102, and the fixing members 106 are used to fix the dripping hose units 104.

The fixing members 106 are formed in a stapler shape, the downward fixing legs 34 are formed on both sides of each of the fixing members 106, and the fixing members 106 are fixed by inserting the fixing legs 34 into the pin holes 16 and driving them into a ridge.

In this case, the fixing members 106 are driven and fixed by surrounding the two dripping hose units 104 so that the two dripping hose units 104 cannot be moved.

The irrigation supply connection valve 108 is connected to the supply hose part bodies 10 and 11 of the geothermal hose unit 102 installed as described above, the irrigation valve discharge valve 110 is connected to the discharge hose part 12, and the supply valves 112 are installed in the dripping hose units 104.

FIG. 3 is a sectional view of the present invention. The ridge 300 is formed to cultivate crops such as watermelons and strawberries. The local cold/warm pad 100 of the present invention is installed on top of the ridge 300. The geothermal hose unit 102 and the dripping hose units 102 are fixed by driving the fixing members 106 into the top of the ridge 300. Strawberry seedlings 200 are planted on both sides of the geothermal hose unit 102.

Thereafter, cold water or hot water is supplied to the geothermal hose unit 102. That is, the geothermal temperature is lowered and maintained at 20° C. suitable for strawberry cultivation by supplying cold water in summer, and geothermal heat is increased by supplying hot water in winter, so that the ridge 300 is adjusted to have geothermal heat under uniform conditions so that the strawberry seedlings 200 grow well.

In addition, the strawberry seedlings 200 are suddenly cooled by supplying cold water to the dripping hose 104, so that a shock can be applied to the strawberry seedlings 200 due to a change in temperature so that the differentiation of strawberries can be performed multiple times. That is, in general, cold water is sprayed using a separate hose in order to perform differentiation two or more times. In the present invention, cold water is supplied by the dripping hose units 104.

FIG. 4 is an installation state diagram of the present invention. The ridge 300 for cultivating crops such as strawberries is formed, and the local cold/warm pad 100 of the present invention is installed on top of the ridge 300.

In this case, the geothermal hose unit 102 and the dripping hose units 104 are buried in the ridge 300 to have appropriate heights. In this case, the dripping hose units 104 should neither protrude excessively high above the ridge nor be buried excessively low. The reason for this is that the nozzle holes 32 are covered with soil and also drip supply is impossible when the dripping hose units 104 are excessively buried and a large amount of water is supplied excessively widely when the dripping hose units 104 are excessively high, resulting in an unnecessary loss.

Thereafter, after the geothermal hose unit 102 and the dripping hose units 104 have been buried in the top of the ridge 300, the dripping hose units 104 are fixed without being separated by driving the plurality of fixing members 106 into the ridge 300, and at the same time, the geothermal hose unit 102 is firmly installed such that it is not moved downward, shaken, or separated from the ridge 300.

Thereafter, the roots of the strawberry seedlings 200 may be covered with a mulching film configured to promote the growth of strawberries by improving rooting, maximizing soil utilization and also activating the ventilation of the roots through pores.

The above-described present invention is not limited to the preferred embodiments described above. It is obvious that those skilled in the art may make modifications into various materials and shapes without departing from the gist of the present invention claimed in the claims of the present invention. It will be appreciated that such modifications fall within the scope of the claims described as essential components of the present invention.

1. A local cold/warm pad for strawberry cultivation, the local cold/warm pad comprising:
a geothermal hose unit (102) configured such that supply hose part bodies (10 and 11) through which cold water or hot water is supplied are formed, a discharge hose part (12) is formed between the supply hose part bodies (10 and 11), the discharge hose part (12) and the supply hose part bodies (10 and 11) are fused to form fusion portions (14), and a plurality of pin holes are formed in the fusion portions (14);
dripping hose units (104) seated on and fixed to the fusion portions (14), and provided with a plurality of nozzle holes (32) for supplying irrigation water to crops; and
fixing members (106) configured to fix the dripping hose units (104) seated on the fusion portions so that the dripping hose units (104) are not shaken or separated.

2. The local cold/warm pad of claim 1, wherein the geothermal hose unit (102) and the dripping hose units (104) are located on top of a ridge (300), strawberry seedlings are planted on left and right sides of the geothermal hose unit (102), and cold irrigation water is supplied from the dripping hose units (104) so that differentiation can be performed at least twice.

3. The local cold/warm pad of claim 1, wherein the geothermal hose unit (102) is formed of the supply hose part bodies (10 and 11) and the discharge hose part (12), one end of the geothermal hose unit (102) is formed such that the supply hose part bodies (10 and 11) and the discharge hose part (12) are connected to each other so that irrigation water can be circulated therethrough, installation is made such that irrigation water supplied to the supply hose part bodies (10 and 11) is circulated and discharged to the discharge hose part (12), and installation is made such that a sum of a temperature of irrigation water supplied and a temperature of irrigation water discharged is kept uniform throughout hoses extending from a front end of the geothermal hose unit (102) to a rear end thereof.
